(19) United States
(12) Patent Application Publication
(10) Pub. No.: US 2002/0132109 A1
(43) Pub. Date: Sep. 19, 2002

(54) REFLECTIVE OPTICAL ELEMENT AND METHOD OF PRODUCING THE SAME

(76) Inventors: HIDEYUKI HATAKEYAMA, YOKOHAMA-SHI (JP); MASANOBU OHGANE, YOKOHAMA-SHI (JP)

Correspondence Address: FITZPATRICK CELLA HARPER & SCINTO, 30 ROCKEFELLER PLAZA, NEW YORK, NY, 10112, US

(21) Appl. No.: 09/391,518

(22) Filed: Sep. 8, 1999

(30) Foreign Application Priority Data
Sep. 14, 1998 (JP) 260354/1998

(51) Int. Cl. B32B 15/08; B05D 1/18

(52) U.S. Cl. 428/336; 428/463; 428/461; 427/443.1; 427/164

(57) ABSTRACT

A reflective optical element includes a transparent resinous substrate and a highly reflective silver film formed on the substrate by at least a wet film formation technique, and a target image is obtained by utilizing reflection on the surface of, or at the back of, the highly reflective silver film. The method of producing this optical element is also disclosed. The silver film constituting the optical element is excellent in reflection characteristics without showing unevenness in film, and is satisfactory in adhesion with the substrate.

### BACKGROUND OF THE INVENTION

1. Field of the Invention

The present invention relates to a reflective optical element. More particularly, it relates to wet film formation of a highly reflective silver film formed on a substrate of the reflective optical element and to the film configuration thereof.

2. Description of the Related Art

Reflective optical elements are used to obtain a target image by utilizing reflection on the surface of, or at the back of, a metal. As highly reflective films formed on the surfaces of such reflective optical element, aluminium, silver or other metallic films each having a high reflectance have been employed. Especially, silver has a markedly high reflectance in the visible region (in the range of a wavelength λ of 350 to 700 nm), and therefore is in wide use in mirrors and reflective optical element.

Aluminum, silver and other metallic films are generally formed by, for example, vacuum deposition, sputtering, ion plating or another vacuum dry film formation technique.

Alternatively, a silver mirror reaction is known as a wet film formation technique of a silver film, and this technique is applied to the manufacture of, for instance, mirrors and vacuum bottles.

These conventional techniques for the formation of highly reflective silver films have, however, the following disadvantages.

Highly reflective silver films used for reflective optical elements have been generally formed by vacuum deposition, sputtering, ion plating or another vacuum dry film formation technique, as described above.

However, optical elements having complicated shapes such as fine, irregular or multifaceted shapes, as described in Japanese Patent Laid-Open No. 8-90229, have been increased. Optical elements having these complicated shapes cannot be produced by the conventional techniques for vacuum dry film formation, or if possible, facilities and processes necessary for the film formation become complicated, resulting in increased costs for the film formation.

Separately, demands for the use of resins as the substrates of reflective optical elements have been increased with reducing weights of optical elements. Resin substrates are, however, low in adhesion with respect to silver films formed according to the conventional techniques for vacuum dry film formation.

### SUMMARY OF THE INVENTION

Accordingly, it is an object of the present invention to provide an optical element including a substrate and a highly reflective silver film formed on the substrate, which silver film can be formed with facility even when the substrate has a complicated shape.

Another object of the invention is to provide an optical element including a substrate and a highly reflective silver film formed on the substrate, which silver film is excellent in adhesion to the substrate.

A further object of the invention is to provide a method of producing the aforementioned optical element.

The invention therefore provides, in an aspect, a reflective optical element including a transparent resinous substrate, and a highly reflective silver film formed on the substrate by at least a wet film formation technique, to give a target image utilizing reflection on the surface of, or at the back of, the highly reflective silver film.

In the reflective optical element of the invention, a wet film formation technique is used for the formation of a highly reflective silver film on a transparent resinous substrate. Consequently, a reflective optical element having a highly reflective silver film uniformly formed on a substrate can be obtained with facility, even when the substrate has a fine, irregular, multifaceted or another complicated shape.

The reflective optical element of the invention has a highly reflective silver film excellent in adhesion to the resinous substrate in comparison with conventional equivalents formed by the vacuum dry film formation technique.

The invention provides, in another aspect, a method of producing a reflective optical element, the method including the step of forming a highly reflective silver film on a transparent resinous substrate by at least a wet film formation technique, to form a target image utilizing reflection on the surface of, or at the back of, the highly reflective silver film.

### BRIEF DESCRIPTION OF THE DRAWINGS

FIG. 1 is a cross sectional view showing a basic film configuration of a reflective optical element according to the invention;

FIG. 2 is a cross sectional view showing a basic film configuration of a reflective optical element indicated in Example 1;

FIG. 3 is a cross sectional view showing a basic film configuration of a reflective optical element indicated in Example 2;

FIG. 4 is a cross sectional view showing a basic film configuration of a reflective optical element indicated in the Example 2; and

FIG. 5 is a cross sectional view showing a basic film configuration of a reflective optical element indicated in Example 3.

### DESCRIPTION OF THE PREFERRED EMBODIMENT

The reflective optical element according to the invention may have, as preferred embodiments, the following configurations in which:

(1) the substrate is preferably composed of an amorphous polyolefin resin;

(2) the wet film formation technique is preferably an electroless plating technique, that is, a process comprising the steps of reducing silver ions in a plating bath by a catalytic metal on the surface of the substrate, and depositing silver to form a silver film;

(3) the optical element preferably has a film laminate obtained by laminating a low refractive film and a high refractive film in this order at least from the silver film side, the film laminate being interposed between the substrate and the highly reflective silver film or in the rim of the highly reflective silver film. In other words, the optical element may have a configuration composed of a high refractive film (e.g., of TiO2, ZnO2, or Al2O3), a low refractive film (e.g., of SiO2) and a highly reflective silver film formed in this order on the surface of the substrate, or a configuration composed of a highly reflective silver film, a low refractive film and a high refractive film formed in this order on the surface of the substrate. The laminate of the high refractive film and low refractive film serves as a film for increasing the reflection.

(4) The highly reflective silver film preferably has a thickness ranging from 50 nm to 1000 nm and a reflectance of equal to or more than 80% on light having a wavelength of 400 nm.

Transparent resins to be used as the substrate in the invention are not limited, as far as they have sufficient rigidity and transparency as optical elements, and include, for instance, acrylic resins, polycarbonate resins, and amorphous polyolefin resins. Among them, preferred are amorphous polyolefin reins typically having the following structural formula:

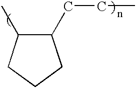

where n is a positive integer.

The amorphous polyolefin resins are low in moisture absorbency (of equal to or less than 0.01%, as determined by a method according to Japanese Industrial Standards (JIS) 6911), are low in temperature dependency of refractive index, are hardly deformed by heat, and are optically stable. These resins are therefore advantageously used as a substrate of the optical element.

The use of an amorphous polyolefin resin as the substrate of the optical element improves the environmental resistance and shelf stability of the optical element.

As techniques for wet film formation of the highly reflective silver film, there may be mentioned a silver mirror reaction, electroplating, and electroless plating. Among these techniques, the electroless plating is typically preferred, because this technique has the following advantages:

(1) There is no need of forming a conductive layer as a contact on a substrate, and the resultant optical element after the formation of a silver film is high in reflectance from the substrate side.

(2) A deposition reaction of silver is allowed to occur selectively on the substrate, and the obtained silver film is very uniform without having an uneven film thickness, and the overall optical element has little irregularities in reflectance.

(3) The reaction rate of deposition of silver can be controlled by adjusting the composition of a plating bath to be used, avoiding waste of the plating bath.

(4) The formation of silver fulminate can be prevented by adjusting the composition of the plating bath.

Electroless plating is generally carried out by adding a catalytic metal or catalytic metal ion to a substrate, and dipping the catalyst-carrying substrate in a plating bath. The catalytic metal or metal ion is added to enhance the reaction of metal deposition from a plating bath. By the above procedure, a reaction of metal deposition occurs on the substrate and thus the substrate is plated.

The catalytic metals or catalytic metal ions to be used for enhancing the reaction of metal deposition on a substrate from a plating bath are not limited, as far as they can proceed the reaction of silver deposition from an electroless silver plating bath, and include, for example, gold, silver, copper, palladium, cobalt, tin, nickel and other metals, and ions of these metals, and colloids containing any of these metals and metal ions.

The surface of the substrate may be subjected to a pretreatment in order to add the catalytic metal or catalytic metal ion uniformly on the surface. Such pretreatment procedures include acid-alkali etching, UV-O3 treatment (ultraviolet-ozone treatment), corona discharge treatment, excimer irradiation treatment and other treatments for reducing the surface energy of the substrate; and hydrophilization of the surface of the substrate with a surfactant or another substance having a polar group. These treatments can be carried out singly or in combination to add the catalytic metal or catalytic metal ion to the substrate.

Some of the catalytic metal ions are low in adsorptivity to the substrate and leave from the substrate into a plating bath, thereby enhancing the decomposition of the plating bath. In this case, it is preferable to reduce the catalytic metal ion and to fix it on the substrate as a catalytic metal. Reducing agents to be used in this procedure are not particularly limited.

The electroless plating bath is composed of soluble silver ions, a reducing agent for reducing silver ions to deposit on the substrate of optical element, a chelator to form a chelate with silver ions and to stabilize the plating bath, and a pH adjuster for preventing the driving force of a plating reaction from decreasing. In this connection, the driving force is decreased with increasing hydrogen ions which are formed by oxidation of the reducing agent.

Reducing agents to be used are not limited, as far as they are substances which can reduce silver ions dissolved in the plating bath, and generally include formaldehyde, Rochelle salts, hydrazine, and hydrazine borane. Cobalt sulfate can also be used as the reducing agent, as is described in Surface and Coatings Technology; 82(1996) 165-168.

Chelators to be used are not limited as far as they can form chelates with silver ions dissolved in the plating bath and inhibit a deposition reaction of silver from the plating bath, and deposit silver on the substrate through the catalyst attached to the substrate with facility. As such a chelator, cyanogen may be used, but it is a very dangerous substance and requires extremely careful handling. Consequently, ammonia or an ammonia derivative can be used as the chelator, as is described in Surface and Coatings Technology; 82(1996) 165-168.

The highly reflective silver film formed by electroless plating preferably has a reflectance of equal to or more than 80% (λ=400 nm). The thickness of this film is preferably equal to or more than 50 nm for ensuring the reflectance to be within the above range.

The film thickness is desirably equal to or less than 1000 nm for the purpose of suppressing crack formation (particularly in regions of the substrate where its curvature is high) due to a stress of deposition of silver when the silver film is formed.

The wet film formation process of the highly reflective silver film of the reflective optical element according to the invention will be described in detail with reference to the drawings and tables of test results of several inventive examples and comparative examples which are not directed to limiting the scope of the invention.

### EXAMPLE 1

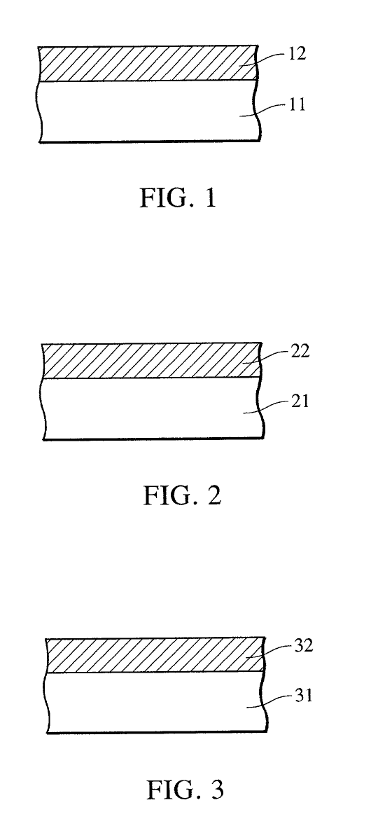

FIG. 1 is a diagram showing the basic configuration of a highly reflective silver film of the reflective optical element according to the invention, in which highly reflective silver film 12 is formed on transparent resinous substrate 11.

In this example, the substrate 12 of an acrylic resin (trade name: Delpet, Asahi Chemical Industry, Co., Ltd., Japan) having five reflective surfaces each oriented in a different direction was used in the following test. In FIG. 2, the configuration of one reflective surface is shown. In this example, highly reflective films must be formed on the surfaces of all the five surfaces each oriented in a different direction in order that the acrylic resin substrate serves as an optical element.

The film configuration of films according to the present example and the test results thereof are shown in FIG. 2 and Table 1, respectively.

TABLE 1

| | Film | Number of | Thickness | | | |
|---|---|---|---|---|---|---|
| | formation | film | of silver | Reflectance | | |
| | technique | formations | film | (l = 500 nm) | Adhesion | Uneven film |
| Comp. Ex. 1 | vacuum | 5 | 200 nm | 96% | x | ∘ |
| | deposition | | | | | |
| Experimental | Silver | 1 | 200 nm | 96% | Δ | Δ |
| Ex. 1 | mirror | | | | | |
| | reaction | | | | | |
| Experimental | Electroless | 1 | 200 nm | 96% | ∘ | ∘ |
| Ex. 2 | plating | | | | | |

Reflectance: the reflectance of one surface was determined
Adhesion: cellophane tape peel test
∘ no peeling
Δ partially peeling
x overall peeling
Uneven film: visual inspection
Δ film was even
∘ film was partially uneven

Comparative Example 1: A silver film was formed on the acrylic resin substrate 21 by vacuum deposition, while adjusting the thickness of the resultant silver film to 200 nm. To form silver films on all the five reflective surfaces of the acrylic resin substrate, vacuum deposition was required to repeat five times with changing the orientation of the substrate.

The silver film thus formed had a reflectance of 96% (λ=500 nm). Stripping of this film was observed in an adhesion test shown below. Separately, no unevenness in film was observed.

Experimental Example 1: A silver film was formed on the acrylic resin substrate 21 by a silver mirror reaction, while adjusting the thickness of the resultant silver film to 200 nm.

The silver mirror reaction was conducted in the following manner.

Initially, 60 g of silver nitrate was added and dissolved in 1 liter of pure water and the resultant solution was stirred. Subsequently, a 28% aqueous ammonia was continuously added dropwise to the above solution until the solution once became brown and then became transparent to give a silver solution. In this step, the amount of the added aqueous ammonia was approximately 60 g. The acrylic resin substrate 21 was dipped in the silver solution, and a 10% formaldehyde aqueous solution was added to the silver solution with stirring to conduct the silver mirror reaction. Thus, silver was deposited on the substrate.

The obtained silver film had a reflectance of 96% (λ=500 nm). Partial stripping of this film was observed in the adhesion test shown below.

The surface of, and the thickness of the silver film were uneven.

Experimental Example 2: A silver film was formed on the acrylic resin substrate 21 by electroless plating, while adjusting the thickness of the silver film to 200 nm.

The electroless plating was carried out in the following manner.

Initially, the acrylic resin substrate 21 was dipped in a 20 ml/l aqueous solution of a surfactant (trade name: Predip Neoganth B; Atotech Japan Co., Ltd., Japan) for 1 minutes, and was then dipped in a 50 ml/l aqueous solution of an activator (trade name: Activator Neoganth 834 conc; Atotech Japan Co., Ltd., Japan) at 35° C. for 5 minutes, to add a palladium catalyst to the substrate. After the activation, the substrate was washed with water for 2 minutes, and was then dipped in a 5 ml/l aqueous solution of a reducing agent (trade name: Reducer Neoganth WA; Atotech Japan Co., Ltd., Japan) for 5 minutes to reduce palladium ions. The substrate was then washed again with water for 2 minutes and dipped in an electroless plating bath having the composition indicated in Table 2 for 10 minutes to conduct electroless plating. Thus silver was deposited on the substrate.

The obtained silver film had a reflectance of 96% (λ=500 nm). Stripping of this film was observed in the adhesion test shown below.

Separately, unevenness of the silver film was not observed.

TABLE 2
Composition of electroless silver plating bath

| | Concentration and | |
|---|---|---|
| Component and parameter | parameter | |
| Silver nitrate | 6.8 | g/l |
| Cobalt sulfate heptahydrate | 28 | g/l |
| 28% aqueous ammonia | 121 | g/l |
| Ammonium sulfate | 99 | g/l |
| pH | 10.0 | |

| | |
|---|---|
| Temperature | Room temperature |

### EXAMPLE 2

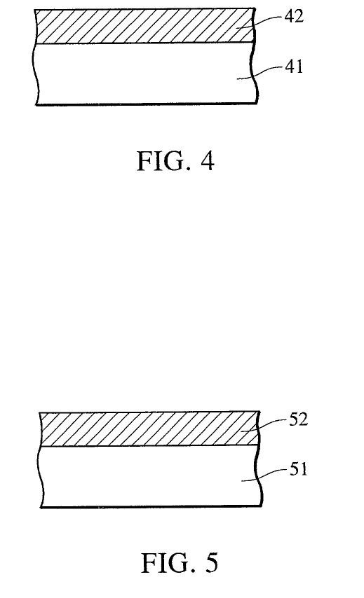

The film configuration of films according to the present example and the test results thereof are shown in FIGS. 3 and 4, and Table 3, respectively.

TABLE 3

| | | Environmental | Shelf |
|---|---|---|---|
| | Substrate | resistance | stability |
| Experimental | Acrylic resin | Distortion in | Decrease in |
| Ex. 3 | (Delpet; Asahi Chemical | reflected | reflectance |
| | Industry Co., Ltd.) | image | |
| Experimental | Amorphous polyolefin | ◯ | ◯ |
| Ex. 4 | resin (Zeonex E48R; | | |
| | Nippon Zeon Co., Ltd.) | | |

Environmental resistance: reflected image observation and visual inspection under conditions of 45° C. and 90% relative humidity
Shelf stability: the reflectance determined after allowing a test piece under conditions of 60° C. and 90% relative humidity

Experimental Example 3: A silver film was formed on acrylic resin substrate 31 by electroless plating, while adjusting the thickness of the resultant silver film to 200 nm.

The electroless plating was carried out in the following manner.

Initially, the acrylic resin substrate 31 was dipped in a 20 ml/l aqueous solution of the surfactant (Predip Neoganth B) for 1 minute, and was dipped in a 50 ml/l aqueous solution of the activator (Activator Neoganth 834 conc) at 35° C. for 5 minutes to add a palladium catalyst to the substrate. After the activation, the substrate was washed with water for 2 minutes, and was then dipped in a 5 ml/l aqueous solution of the reducing agent (Reducer Neoganth WA) for 5 minutes to reduce palladium ions. The substrate was washed again with water for 2 minutes and was dipped in an electroless plating bath having the composition indicated in Table 2 for 10 minutes to conduct electroless plating. Silver was thus deposited on the substrate.

The acrylic resin substrate having the highly reflective silver film thus formed was introduced into an optical tester, and was subjected to a reflected image observation under conditions of 45° C. and 95% relative humidity, showing a partial distortion in reflected image.

Separately, the above test piece was allowed to stand at 60° C. and 90% relative humidity for 500 hours, and then the reflectance of the silver film was found to be decreased to 92% (λ=500 nm), whereas it was 96% at the beginning of the test.

Experimental Example 4: On substrate 41 of an amorphous polyolefin resin (trade name: Zeonex E48R; Nippon Zeon Co., Ltd., Japan) was formed silver film 42 by electroless plating, while adjusting the thickness of the resultant silver film to 200 nm, as shown in FIG. 4.

The electroless plating was carried out in the following manner.

Initially, the amorphous polyolefin resin substrate 41 was subjected to corona discharge treatment on its surface, and was then dipped in a 20 ml/l aqueous solution of the surfactant (Predip Neoganth B) for 1 minute, and was dipped in a 50 ml/l aqueous solution of the activator (Activator Neoganth 834 conc) at 35° C. for 5 minutes to add a palladium catalyst. After the activation, the substrate was washed with water for 2 minutes, and was then dipped in a 5 ml/l aqueous solution of the reducing agent (Reducer Neoganth WA) for 5 minutes to reduce palladium ions. The substrate was washed again with water for 2 minutes and was dipped in an electroless plating bath having the composition indicated in Table 2 for 10 minutes to conduct electroless plating. Silver was thus deposited on the substrate.

The substrate of amorphous polyolefin resin having the highly reflective silver film thus formed was introduced into an optical tester, and was subjected to a reflected image observation under conditions of 45° C. and 95% relative humidity, showing no distortion in reflected image.

Separately, the above test piece was allowed to stand at 60° C. and 90% relative humidity for 500 hours, and the reflectance of the silver film after the test was not decreased, while it was 96% (λ=500 nm) at the beginning of the test.

### EXAMPLE 3

The film configuration of films according to the present example and the test results thereof are shown in FIG. 5, and Table 4, respectively.

TABLE 4

| | Plating | Thickness | | |
|---|---|---|---|---|
| | time | of silver | Reflectance | |
| | (min) | film | (400 nm) | Crack formation |
| Experimental | 3 | 60 | 78% | None |
| Ex. 5 | | | | |
| Experimental | 10 | 200 | 88% | None |
| Ex. 6 | | | | |
| Experimental | 30 | 1000 | 88% | Cracks formed |
| Ex. 7 | | | | (many at edges of |
| | | | | substrate) |

Experimental Examples 5, 6 and 7: On substrate 51 of an amorphous polyolefin resin (trade name: Zeonex E48R; Nippon Zeon Co., Ltd., Japan) was formed silver film 52 by electroless plating, while adjusting the thickness of the resultant silver film to 60 nm (Experimental Example 5), 200 nm (Experimental Example 6) or 1000 nm (Experimental Example 7).

The electroless plating was carried out in the following manner.

Initially, the substrate 51 of amorphous polyolefin resin was subjected to corona discharge treatment on its surface, and then was dipped in a 20 ml/l aqueous solution of the surfactant (Predip Neoganth B) for 1 minute, and was dipped in a 50 ml/l aqueous solution of the activator (Activator Neoganth 834 conc) at 35° C. for 5 minutes to add a palladium catalyst to the substrate. After the activation, the substrate was washed with water for 2 minutes, and was then dipped in a 5 ml/l aqueous solution of the reducing agent (Reducer Neoganth WA) for 5 minutes to reduce palladium ions. The substrate was washed again with water for 2 minutes, and was dipped in an electroless plating bath having the composition indicated in Table 2 for 3 minutes (Experimental Example 5), 10 minutes (Experimental Example 6) or 30 minutes (Experimental Example 7) to conduct electroless plating. Silver was thus deposited on each substrate.

In the Experimental Example 5, the resultant silver film had a thickness of 60 nm and a reflectance of 78% (λ=400 nm).

In the Experimental Example 7, the resultant silver film had a thickness of 1000 nm and a reflectance of 88% (λ=400 nm). Some cracks were, however, formed on the silver film.

In this connection, the procedure of the Experimental Example 5 was repeated except that the temperature of the plating was changed from 25° C. to 45° C., and the obtained silver film had a thickness of 60 nm and a reflectance of 82% (λ=400 nm).

Separately, the procedure of the Experimental Example 7 was repeated, except that the plating bath indicated in Table 2 was diluted twice with water and the electroless plating was carried out for 60 minutes, to give a silver film having a thickness of 1000 nm. In this test piece, no crack formation was observed.

Other embodiments and variations will be obvious to those skilled in the art, and this invention is not to be limited to the specific matters stated above.

What is claimed is:

1. A reflective optical element comprising a transparent resinous substrate and a highly reflective silver film formed on said substrate, said silver film being formed by at least a wet film formation technique, to obtain a target image utilizing reflection on the surface of, or at the back of, said highly reflective silver film.

2. A reflective optical element according to claim 1, wherein said substrate is composed of a resin selected from the group consisting of acrylic resins, polycarbonate resins and amorphous polyolefin resins.

3. A reflective optical element according to claim 1, wherein said substrate is composed of an amorphous polyolefin resin.

4. A reflective optical element according to claim 1, wherein said wet film formation technique is a silver mirror reaction.

5. A reflective optical element according to claim 1, wherein said wet film formation technique is electroless plating.

6. A reflective optical element according to claim 1, further comprising a film laminate formed by laminating a low refractive film and a high refractive film in this order at least from said silver film side, said film laminate being interposed between said substrate and said highly reflective silver film or in the rim of said highly reflective silver film.

7. A reflective optical element according to claim 1, wherein said highly reflective silver film has a thickness ranging from 50 nm to 1000 nm, and a reflectance of equal to or more than 80% on light having a wavelength of 400 nm.

8. A method of producing a reflective optical element, said method comprising the step of forming a highly reflective silver film on a transparent resinous substrate by at least a wet film formation technique, to form a target image utilizing reflection on the surface of, or at the back of, said highly reflective silver film.

9. A method according to claim 8, wherein said substrate is composed of an amorphous polyolefin resin.

10. A method according to claim 8 or 9, wherein said wet film formation technique is electroless plating.
